(19) United States
(12) Patent Application Publication
(10) Pub. No.: US 2017/0232445 A1
(43) Pub. Date: Aug. 17, 2017

(54) DEVICE FOR BREAKING GLASS

(71) Applicant: GLASSBUSTERS LIMITED, London (GB)

(72) Inventors: Ian WEBB, London (GB); Peter ANCKETILL, London (GB)

(21) Appl. No.: 15/519,375

(22) PCT Filed: Oct. 15, 2015
(86) PCT No.: PCT/GB2015/053069

§ 371 Date: Apr. 14, 2017

(30) Foreign Application Priority Data
Oct. 15, 2014 (GB) 1418285.1

(51) Int. Cl. B02C 19/00; B02C 13/28; B02C 25/00; B02C 13/09

(52) U.S. Cl. CPC B02C 19/0087; B02C 13/09; B02C 13/2804; B02C 25/00; B02C 2013/28609

(57) ABSTRACT

A device for breaking glass articles, such as bottles, the device comprising an inlet to receive an article. A conduit links the inlet with a glass-breaking chamber, and the chamber houses a glass-breaking member, said glass-breaking member being rotatably mounted for rotation in a vertical plane, and to impact a bottle as a bottle enters the chamber. A motor is linked via a horizontally rotating axle to rotate the glass-breaking member. An obliquely mounted crusher plate is located such that as the glass-breaking member rotates and impacts a glass article, which is forced against the crusher plate by the glass-breaking member to aid breakage of a glass article. A collector is included in which broken glass is retained ready for removal from the device. An intermediate collector is also included to temporarily retain broken glass, including a release valve allowing broken glass to pass from the intermediate collector to the collector, via an aperture therebetween.

### CROSS-REFERENCE TO RELATED APPLICATIONS

This application is a national stage application filed under 35 U.S.C. 371 of International Application No. PCT/GB2015/053069, filed Oct. 15, 2015, which claims priority from Patent Application No. GB 1418285.1, filed Oct. 15, 2014, each of which is incorporated by reference herein in its entirety.

### FIELD OF THE INVENTION

The present invention is to an improved device for breaking glass and glass-like materials, including ceramic materials, and is particularly suitable for breaking glass bottles such as used to hold wines, spirits, beer or the like. The device is especially suited for use in a bar, nightclub, restaurant or similar establishment, and where limited space is available.

### BACKGROUND TO THE INVENTION

In a previous patent application, WO2014/049353, the Applicant disclosed a machine to break glass into small particles, which machine was particularly suitable for use in bars, nightclubs which have a cellar beneath the bar where the glass particles produced could be collected for later disposal. In particular, the glass cullet produced can be removed and made available specifically for remelt. The size of the fragmented particles produced is chosen to ensure the glass is in suitable form for said remelt, allowing new bottles to be formed from the melted material.

However, such an arrangement is not always suitable or possible and the present invention seeks to provide a machine which can be used where space is more limited.

In addition, the present invention also includes a valve which is particularly suited for use in controlling the flow of abrasive particulate material, such as the glass particles produced within the device of the current invention, but also more generally. Presently available valves can be easily damaged because of the abrasive nature of particulate material which can especially damage parts of the valve made of softer materials and also can penetrate between moving parts causing the parts to jam together such that the parts can move only with extreme difficulty.

### SUMMARY OF THE INVENTION

According to a first aspect of the invention there is provided a device for breaking glass articles, such as bottles, used for wines and spirits, the device comprising;

an inlet to receive an article,

a conduit linking the inlet with a glass-breaking chamber, the chamber housing a glass-breaking member, said glass-breaking member being rotatably mounted for rotation in a vertical plane, and to impact a bottle as a bottle enters the chamber;

a motor linked via a horizontally rotating axle to rotate the glass-breaking member;

an obliquely mounted crusher plate located such that as the glass-breaking member rotates and impacts a glass article is forced against the crusher plate by the glass-breaking member to aid breakage of a glass article;

a collector in which broken glass is retained ready for removal from the device;

an intermediate collector to temporarily retain broken glass, including a release valve allowing broken glass to pass from the intermediate collector to the collector, via an aperture therebetween.

The above arrangement allows for a more compact machine to be utilised, enabling smaller establishments to utilise the device.

The crusher plate advantageously includes a rib to assist in the breakage of the glass and especially in shredding of any labels on the glass, which labels can act to hold pieces of glass together and so hinder the breakage process and subsequent passage of broken glass through the release valve.

Preferably, the glass breaking member includes a blade extending perpendicularly from a mounting plate. Further preferably the blade has a generally rectangular profile.

Conveniently the blade includes a cut-out of complementary shape to the rib and which in use passes in close spaced-relationship with said rib as the blade rotates. This configuration provides a non-linear path for a glass bottle to traverse as it passes through the device and reduces the risk of over-large particles of glass going through to the container. Yet further conveniently the blade includes a further cut-out along an edge to provide a further, non-linear path for a glass bottle to traverse, which minimises, for example, the risk of a label passing through to the collector without being shredded.

The device preferably includes an input chute pivotally mounted, such that insertion of a bottle into the chute beyond the mount acts to pivot the chute into a vertically orientated position, releasing the bottle into the conduit. The chute minimises the risk of a person's hand accidentally being caught in the blade. Further preferably pivoting of the chute to the bottle releasing orientation, activates an inlet closure means to reduce the risk of shards of glass produced exiting the inlet and also to prevent a second bottle being immediately inserted into the device and potentially overloading the device.

The mass of glass particles can make opening of a valve difficult and also result in rapid wear and tear on conventional valves. The release valve of the present invention is therefore advantageously mounted on rollers to ease the movement of the valve between an open and a closed position.

Further advantageously the release valve includes a plate element, and yet further advantageously a gripping portion enabling the valve to be operated manually by a user. The plate element enables glass particles to accumulate on its in-use upper surface and to periodically be released to the collector. The device advantageously includes one or more brushes in contact with and extending across the width of the release valve which prevents glass particles from being drawn beyond the edge of the aperture and between the device and the release valve. Damage to the release valve and the device is minimised and the risk of the valve becoming jammed is also minimised.

Preferably, the plate element includes a ridge across the width of the plate element to prevent the plate element from being pulled too far out of the device.

The chute in its rest position advantageously opens onto a back retaining wall to prevent a bottle from sliding too far. The back wall is further advantageously formed of a material having a low co-efficient of friction such as Teflon®, HDPE or UHMWPE to minimise the chance of a bottle engaging the back retaining wall too strongly and the resulting frictional force preventing the chute from pivoting. Yet further advantageously the back retaining wall is concavely curved to assist with movement of the bottle.

Optionally, the conduit comprises sound-insulating material to reduce the noise generated by the device. The sound-insulating material further optionally comprises a perforated metal sheet backed with an absorptive foam or an open-cell material.

Optionally, the rotation of the glass breaking member is at a speed of from 1000-3000 rpm, the value being set to deliver glass particles of a desired particle distribution.

Advantageously, the collector includes one or more sensors, to determine the level of glass within the collector, which level is communicated to a user when the level reaches a preset value. The or each sensor is further advantageously an ultrasonic sensor, conveniently mounted on an upper surface of the collector. Optionally the level at which communication to a user is set at 200 mm from the top or 100 mm.

According to a second aspect of the invention, there is provided a valve for controlling the flow of particulate solid through an aperture, the valve comprising a plate element, moveable between an aperture-spanning position preventing flow and an open position,

the plate element being housed within a valve housing and mounted on rollers to ease movement,

one or more brush elements mounted within the housing, the or each brush element engaging a surface of the plate element to prevent movement of particles beyond the brush and so effectively sweep the plate element as the plate element is moved within the housing.

The risk of the valve jamming is therefore reduced and also damage done to the valve by a particulate material penetrating between the housing and the plate element is reduced.

Preferably, the plate element includes a ridge, across the width of the plate element to prevent the plate element from being pulled too far out of the device.

Advantageously, the plate element includes a gripping portion to facilitate operation of the plate element. Optionally, movement of the plate element is actuated by a motor drive unit.

### BRIEF DESCRIPTION OF THE DRAWINGS

The invention is now described with reference to and as illustrated by the accompanying drawings which show, by way of example only, two embodiments of a device for breaking glass. In the drawing:

FIG. 1 is a side view of a first embodiment of a device, with the side panel removed, immediately prior to insertion of a bottle;

FIG. 2 is the side view of the device of FIG. 1 after insertion of the bottle;

FIG. 3 is the side view of the device of FIG. 1, showing breakage of the bottle;

FIG. 4 is a first perspective view of the device of FIG. 1—side panel removed;

FIG. 5 is a second perspective view of the device of FIG. 1—side panel removed;

FIG. 6 is a side view of a second embodiment of a device, with the side panel removed, immediately prior to insertion of a bottle;

FIG. 7 is the side view of the device of FIG. 1 after insertion of the bottle;

FIG. 8 is the side view of the device of FIG. 1, showing breakage of the bottle;

FIG. 9 is a first perspective view of the device of FIG. 1—side panel removed;

FIG. 10 is a second perspective view of the device of FIG. 1—side panel removed;

FIGS. 11a, 11b are cut away perspective views, illustrating a valve mechanism in more detail;

FIGS. 12a, 12b are sectional views showing a valve mechanism in operation;

FIGS. 13a, 13b illustrate a motor and blade in perspective view and exploded perspective view;

FIGS. 14a, 14b, illustrate a blade and crusher plate in perspective and top view respectively;

FIG. 15 illustrates air circulation within the first embodiment of the device;

FIG. 16 is a perspective view of a two-piece construction for the second embodiment of the device;

FIGS. 17a, 17b illustrate the device on castors for ease of mobility; and

FIG. 18 illustrates a silencer.

### DETAILED DESCRIPTION OF THE INVENTION

The invention as described herein relates to a device to break glass bottles and the like into small particles. The device is particularly suitable for premises such as bars, restaurants in reducing the volume of waste glass produced. This assists in the removal of the glass from the premises and also in the reuse of the glass. The particles produced are of such a size and shape that the overall density is increased over the original bottles which increases the capacity of the device and aids in transportation of the glass from the premises. Moreover, the glass particles are less hazardous to users than larger shards of glass from a broken bottle can be.

The devices disclosed are primarily for use as a standalone unit in the bar and do not need to be placed above a cellar to allow the collector for the broken glass to be placed there.

In their most basic aspect, the devices disclosed herein comprise an inlet for a piece of glassware through which the glassware is introduced, the glassware then falls, under gravity into a rotating blade, driven by a motor, the blade acting to break the bottle into small particles typically 5-30 mm in size which is ideal for glass to be remelted for further use. The particulate glass is then collected in a container such as a hopper for ultimate disposal.

By variation of the speed of the rotation, the shape of the blade etc, the size of the glass particles produced can be varied to suit the end purpose. For example, glass particles below 10 mm in size can be used in water filtration, as part of building aggregate or incorporated into road surfaces. Larger sizes, over 10 mm in size can be recycled and used in the manufacture of new bottles or jars or in glassfibre.

In order to improve the safety of the devices, cut-out switches for the motor are included to prevent a person coming into contact with the blade whilst the blade is moving. Also indicators can be included to make the user aware of when the storage capacity of the device for the broken glass is reaching its limit and action needs to be taken to empty the container.

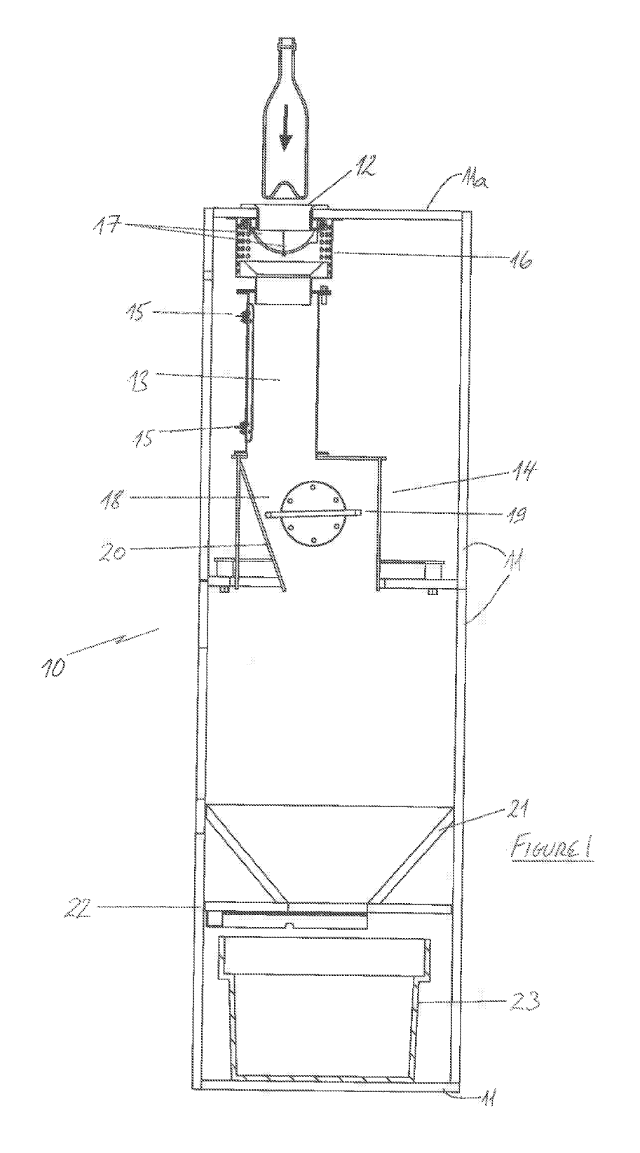

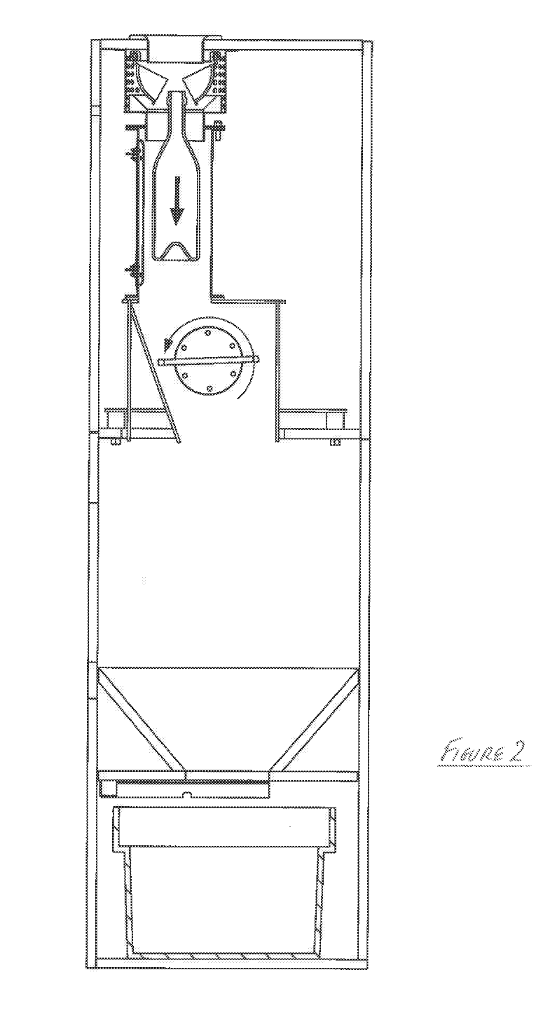

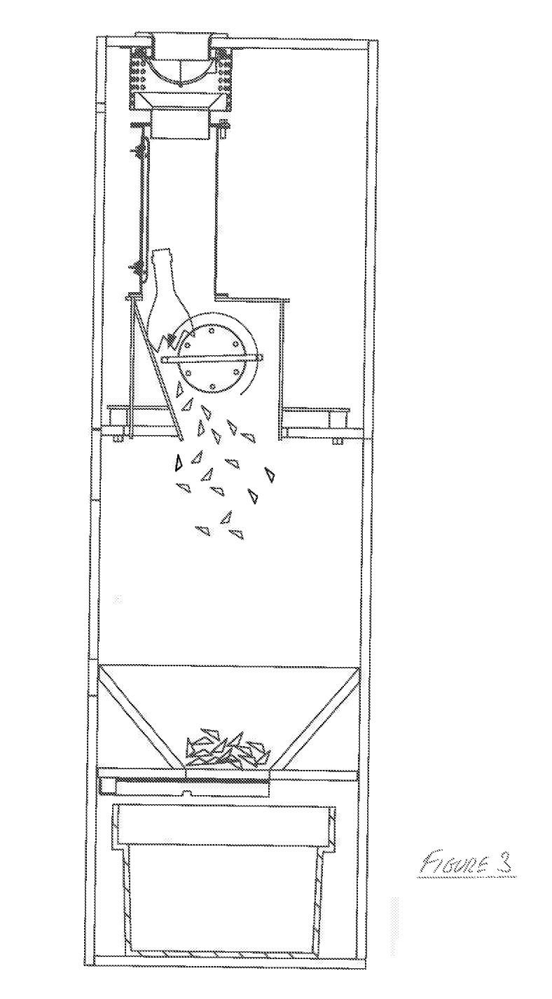

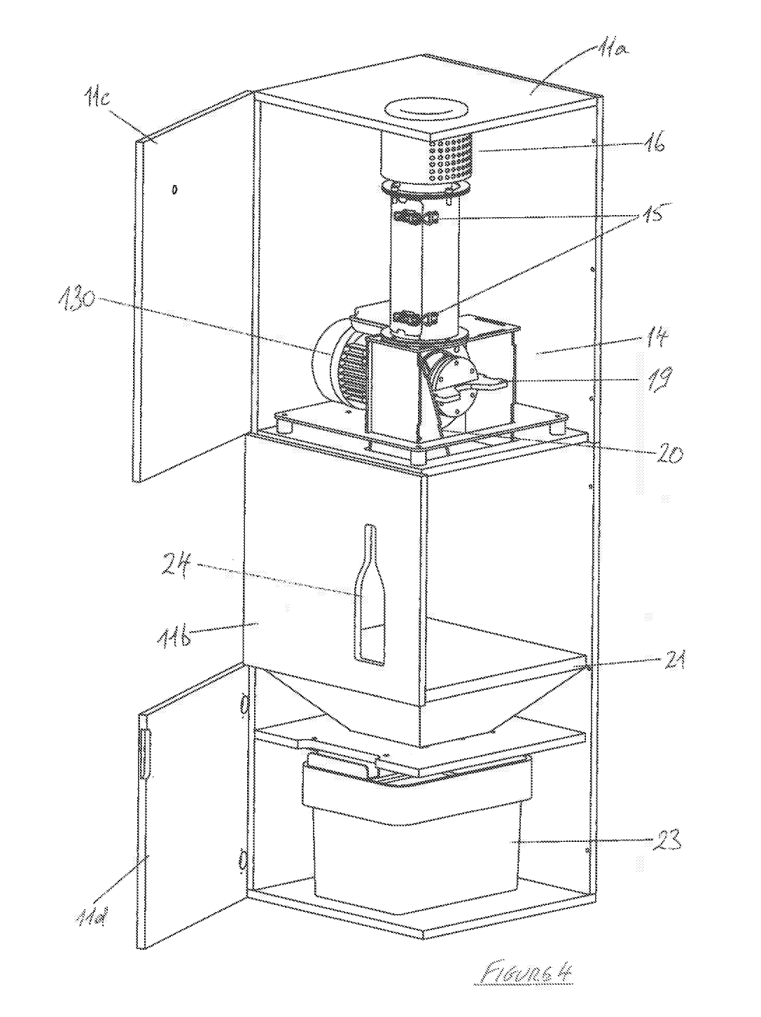

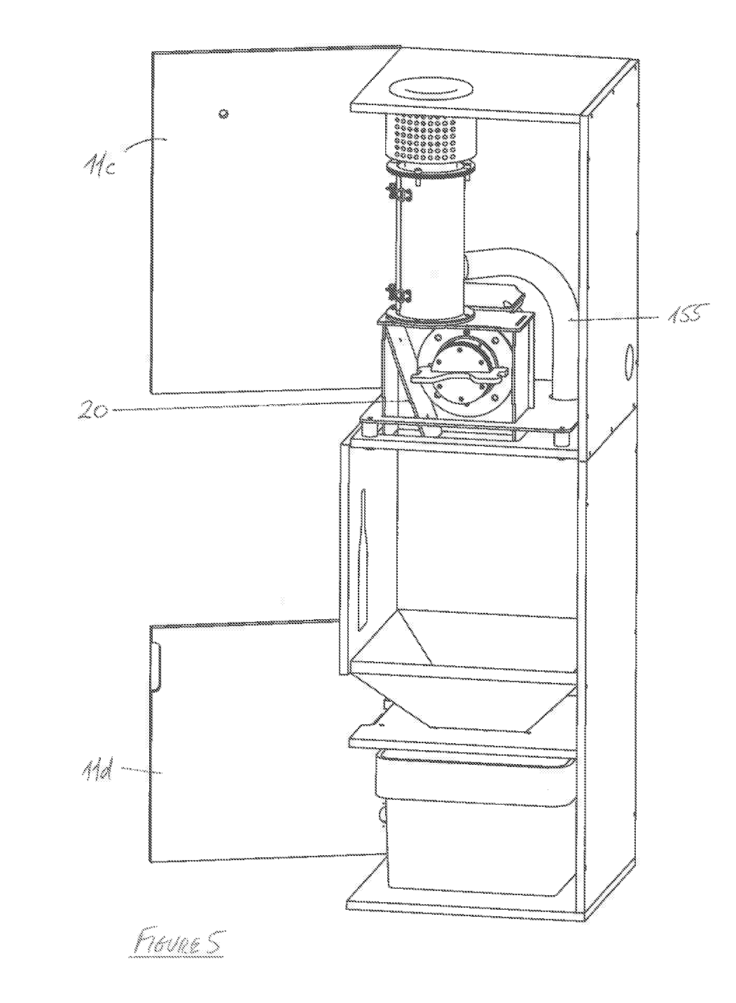

Referring initially to FIGS. 1 to 5, these show a first embodiment of a device, generally referenced 10. The device 10 comprises a housing formed of panels 11 which can be formed of a sheet metal or also of wood which can provide improved sound insulation properties. Set into the top most panel 11a is an inlet 12 which opens into a conduit 13 connecting the inlet 12 with a breakage unit 14. In the embodiment shown, the conduit 13 is openable by means of catches 15 such that in the event of a bottle becoming stuck, the conduit 13 can be opened to assist in clearance of the blockage.

As the device 10 is intended for usage either in, or in close working proximity to a bar, then minimisation of noise created by the device 10 is important. To this end, the inlet is surrounded by a sound-insulating collar 16. The collar 16 has a perforated sheet metal outer layer and inner layers formed of absorptive foam or an open cell material such as fibreglass there between. These elements of the collar 16 combine to reduce the level of sound escaping from the device via the open inlet 12.

To further reduce the escape of sound and also to reduce the risk of glass escaping out of the inlet 12 from the breakage unit 14, sprung flaps 17 are mounted within the inlet's mouth. As a bottle is pushed through the flaps 17, the flaps 17 are pushed apart enabling the bottle to enter the conduit 13. Once the bottle has passed through the flaps 17, springs incorporated in the mounting for the flaps 17 urge the flaps 17 together to close the inlet 12.

In order to reduce noise as well as withstand impact from glass shards, the flaps 17 are formed of a thermoplastic elastomer, such as a polyurethane, polyethylene, or a rubber material.

The conduit 13 opens into the breaking chamber 18 of the breakage unit 14. The breaking chamber 18 houses the rotably mounted blade 19 and the crusher plate 20 which co-operate together in use to break the bottle as it falls through.

The bottle is broken down to a particulate material of the required size and the particles then fall into the hopper 21 where they collect until finally emptied through the valve 22 into the transport container 23. To aid the user in determining the requirement to empty the hopper 21, a window 24 is included in the panel 11b of the device 10. The window 24 is formed of polycarbonate or a toughened glass to resist scratching by the glass particles, which may impact the window 24 at high energy as they are ejected from the breaking chamber 18.

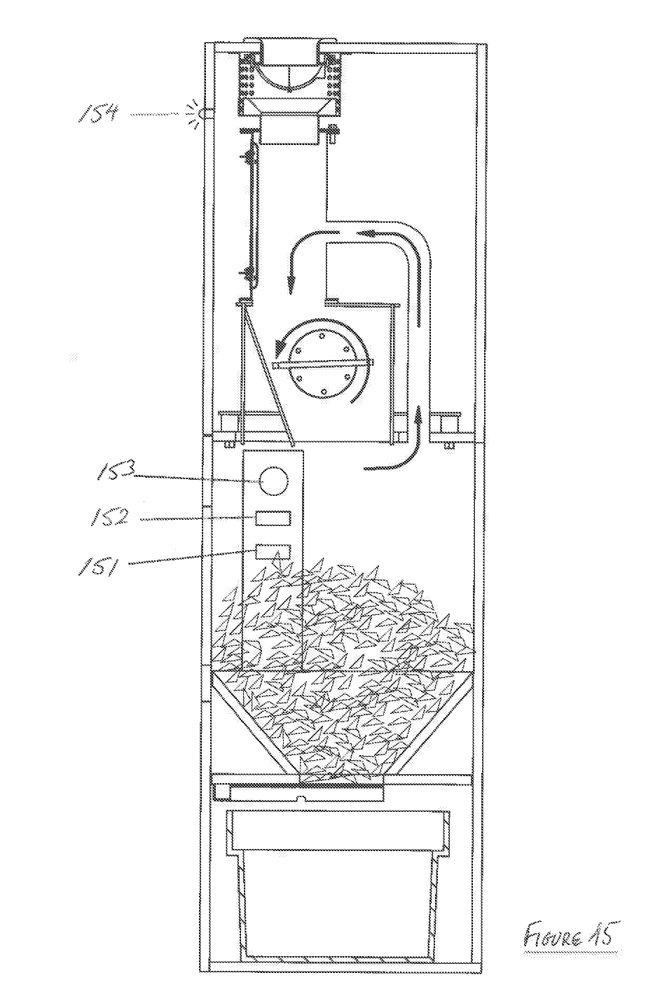

In addition or as an alternative to the window 24, the device 10 can include level sensors and indicators to determine and display the level of glass accumulating in the hopper 21. The sensors 151 to 153 (see FIG. 15) can be ultrasonic, infrared, optical, microwave, pendulum/tilt switch or capacitive sensor which can be set, for example, to show that the level of glass is within 200 mm, 100 mm of the top of the hopper. The level is communicated to the user by a visible or audio signal such as LED light 154 perhaps showing different colours depending on the sensor triggered. In the event that the hopper becomes full, a cut-out switch for the device 10 can be activated preventing further use of the device 10 until the hopper level is reduced. Additionally, safety cut-out switches are provided in the event that the door panels 11c, 11d are opened. This facility can of course be extended to other panels.

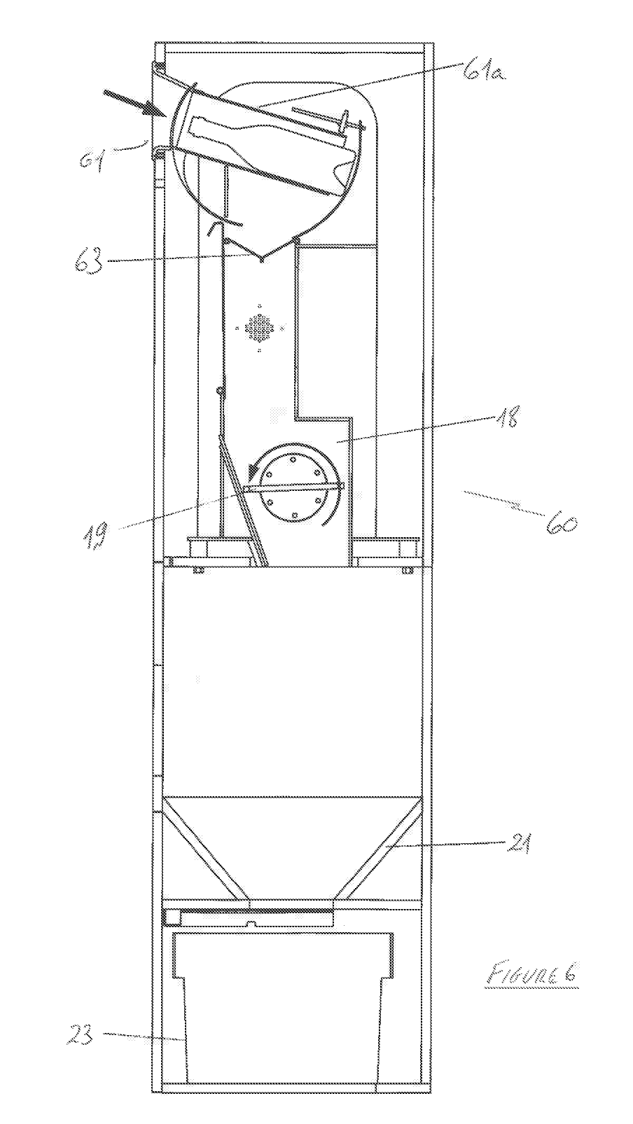

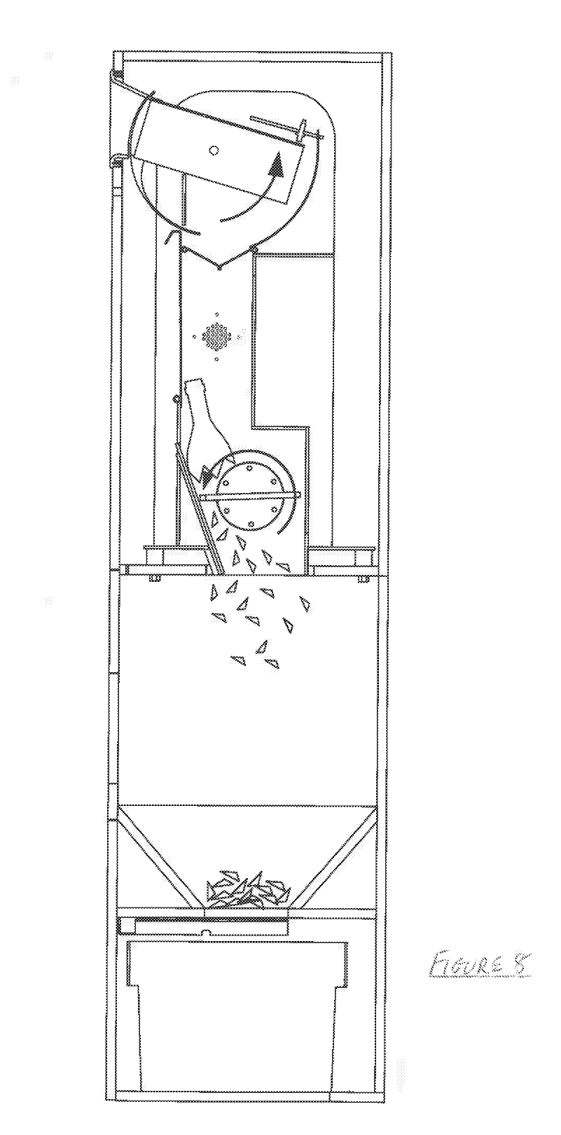

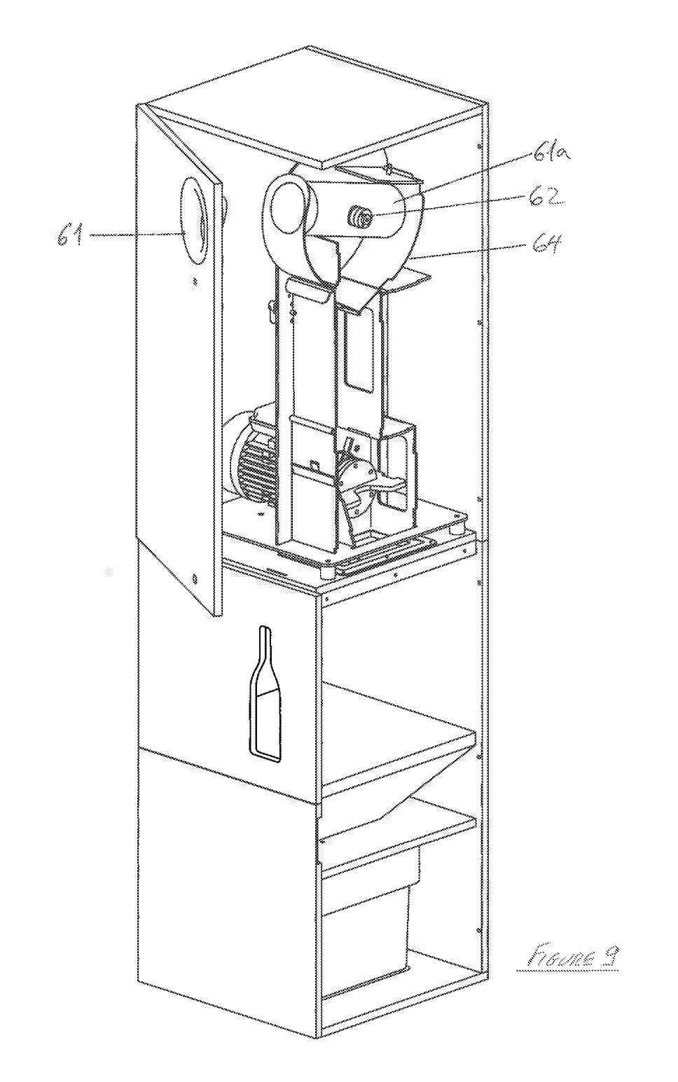

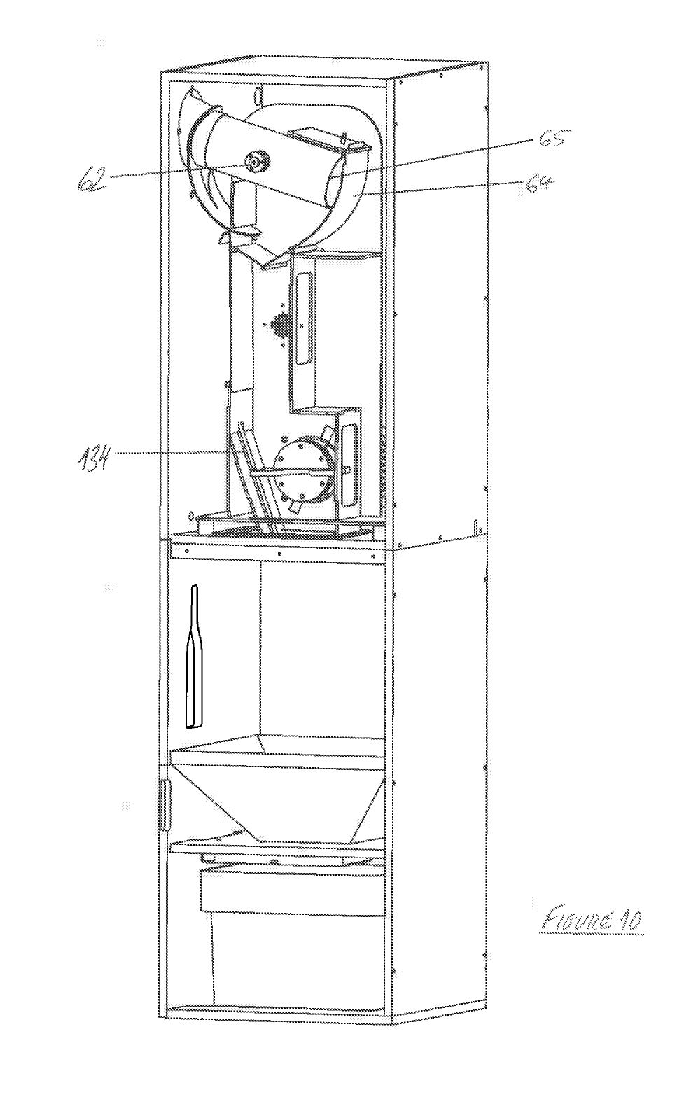

Turning now to the second embodiment of FIGS. 6 to 10, the majority of the device 60 shown therein is as for the first embodiment of FIGS. 1 to 5. Where this is the case, the same numerals will be used for the same features. The inlet however comprises an alternative inlet feed mechanism which allows for safe delivery of bottles and ensures that bottles cannot be inserted too rapidly into the device 60, which may cause the device 60 to jam. Also, the inlet feed mechanism functions most effectively when the bottle is inserted base first, which is also the ideal orientation for the bottle to reach the breaking chamber 18.

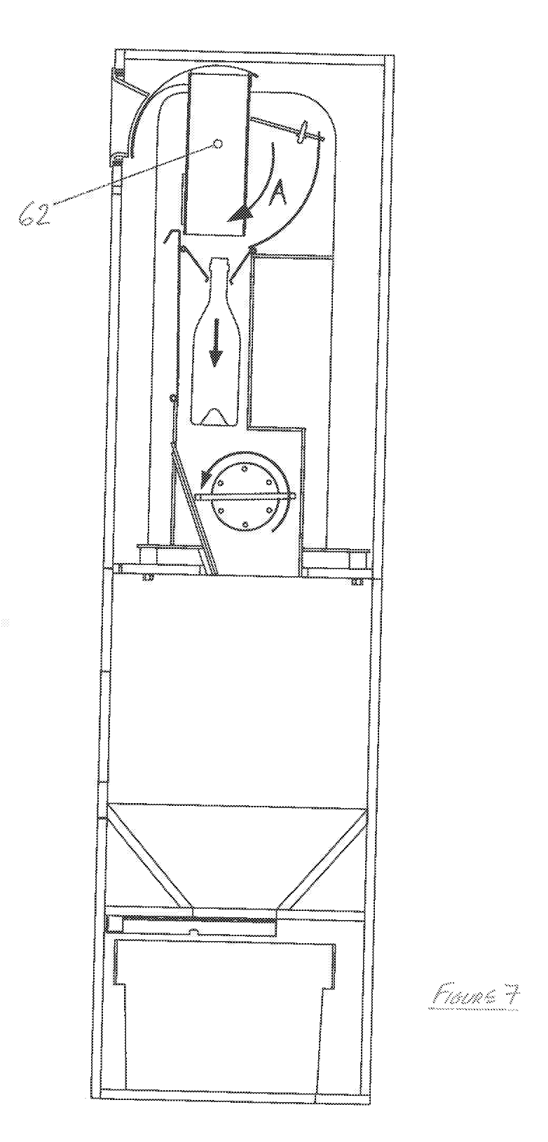

The inlet feed mechanism comprises an inlet 61 leading to a tube 61a, said tube 61a being pivotally mounted on low friction bearings about a horizontally disposed axis 62. Insertion of a bottle into the tube 61a moves the centre of mass of the tube and bottle combined. The balance point of the tube 61a is such that the rotation is caused by bottles of all sizes typical in a bar such as ‘mixer’ bottles and champagne bottles. Eventually insertion of the bottle causes the tube 61a to pivot in the direction shown by the arrow A in FIG. 7, until the tube 61a is vertically orientated. The weight of the bottle then causes the bottle to move downwards which opens the flaps 63 leading into the conduit 13 and onwards to the breaking chamber 18. The bottle is then broken by the blade 19 and the glass particles produces are eventually led into the container 23 in the manner described above for the first embodiment. Once the bottle has dropped from the tube 61a, the tube 61a pivots back returning the tube 61a to an orientation ready to receive a further bottle. Typically, the time from the bottle being released into the tube 61a and returning to its bottle-receiving orientation is 1-2 seconds.

In use therefore and referring to the second embodiment, the user connects the device 60 to a mains AC electricity supply. After checking that the container 23 and the hopper 21 are not full, either by viewing through the window 24 or consulting any indicator 154 present, the user inserts a bottle through the inlet into the tube 61a. Once the bottle is sufficiently within the tube 61a, the mass of the bottle causes the tube 61a to pivot. A flexible retaining wall 64 is mounted at the exit 65 of the tube 61a and is fixed at either end such that the retaining wall 64 describes therebetween a curve which follows the path of the exit 65 as the tube 61a pivots. The retaining wall 64 is preferably formed of a material having a low co-efficient of friction such as Teflon®, HDPE or UHMWPE to minimise the chance of a bottle engaging the back wall too strongly and the resulting frictional force preventing the tube 61a from pivoting.

In an alternative embodiment, not illustrated, a rigid, angled wall can be used in place of the flexible wall.

The pivoting action triggers operation of the motor 130 to cause rotation of the blade 19. Also, as the tube 61a pivots, the opening to the tube is moved away from the inlet 61 which prevents a user from inserting or keeping their hand within the tube 61a. The risk of the user therefore being injured due to rotation of the blade directly or from an inadvertent impact by particles generated by the blade is minimalized. Additionally, the pivoting can cause a cover member 61b to be brought across the opening. The inserted bottle passes down the conduit 13 through the breakage unit 14 to be collected in the hopper and eventually the container. If no further bottles are inserted into the device 60, then the motor is timed to run for an overrun time which can be for example from 5 to 60 seconds.

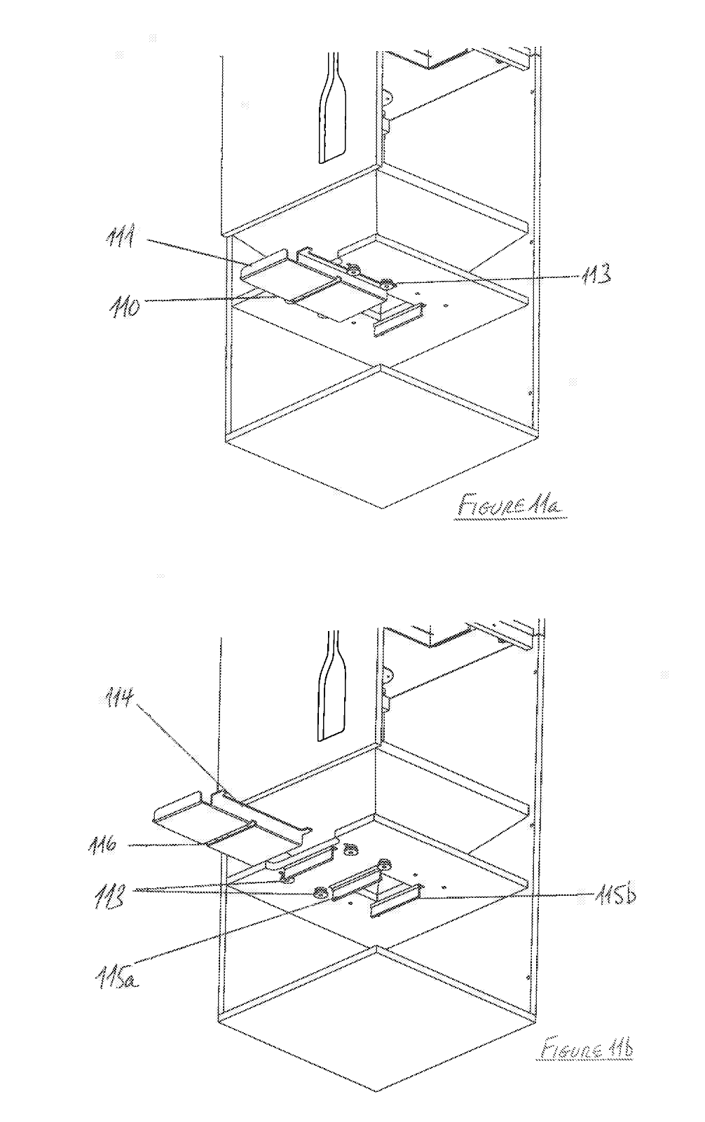

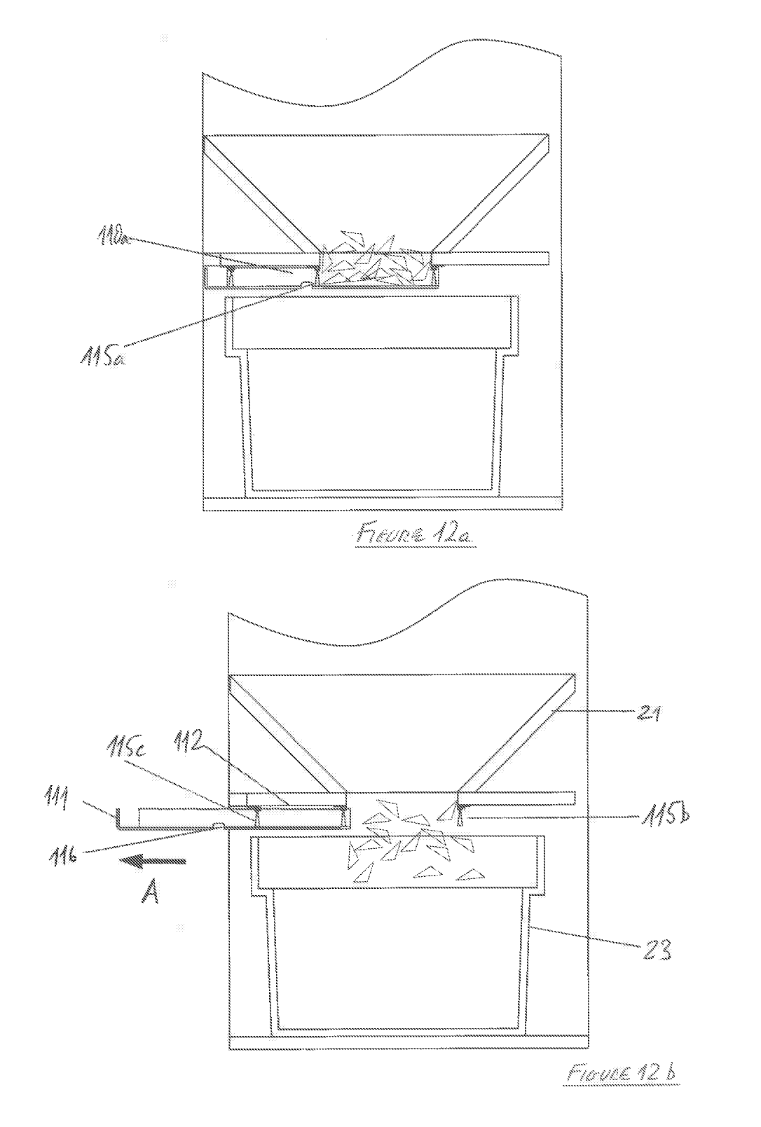

The operation of the valve 22 is now described in more detail with reference to FIGS. 11 and 12. The valve 22 is mounted between the hopper 21 and the transport container 23. As bottles are broken in the breakage unit 14, the particles issuing therefrom are at first collected on the valve plate 110. Once sufficient glass is collected, the valve plate 110 is moved from the closed position shown in FIG. 12a to the open position in FIG. 12b. The glass particles are released into the container 23, following which the valve plate 110 is returned to the closed position. To assist opening and closure, the valve plate 110 is provided with a handle or gripping portion 111. The handle 111 can simply be a fold in the valve plate 110 or can be another type of handle known generally.

In order to reduce damage to the valve plate 110 and penetration of glass particles into the space 110a between the valve plate 110 and the valve plate housing 112, the valve plate 22 includes additional features which prolong the life of the valve 22 and aid in its operation. It will be appreciated that the risk of glass particle penetration into the valve 22 is greatest when the plate 110 is drawn out in the direction of the Arrow in FIG. 12b, although penetration can take place simply by the momentum of the falling particles, causing the particles to rebound into the space 110a. To prevent this therefore the valve plate 110 is mounted on rollers 113 which are prevented from coming into contact with the glass by the configuration of the plate 110. In the embodiment shown, the valve plate 110 is formed along two of its edges into an elongate roller surface 114. In use therefore the roller surface 114 rests on the rollers 113 which enables the plate 110 to be easily moved.

Additionally or alternatively, brushes 115a-c extending across the width of the plate 110 are suspended from the valve plate housing 112. Two of the brushes 115a, b act firstly to prevent the glass particles from moving off the section of the valve plate 110 onto which the particles fall. Secondly, the brushes 115b, c act to sweep the particles towards the aperture connecting the hopper 21 and the container 23 so that the glass particles fall into the container 23 on opening the valve 22. A slot 116 on the valve plate 110 acts as a stop member for closure of the valve plate 110 and again acts as a further barrier for glass particle penetration.

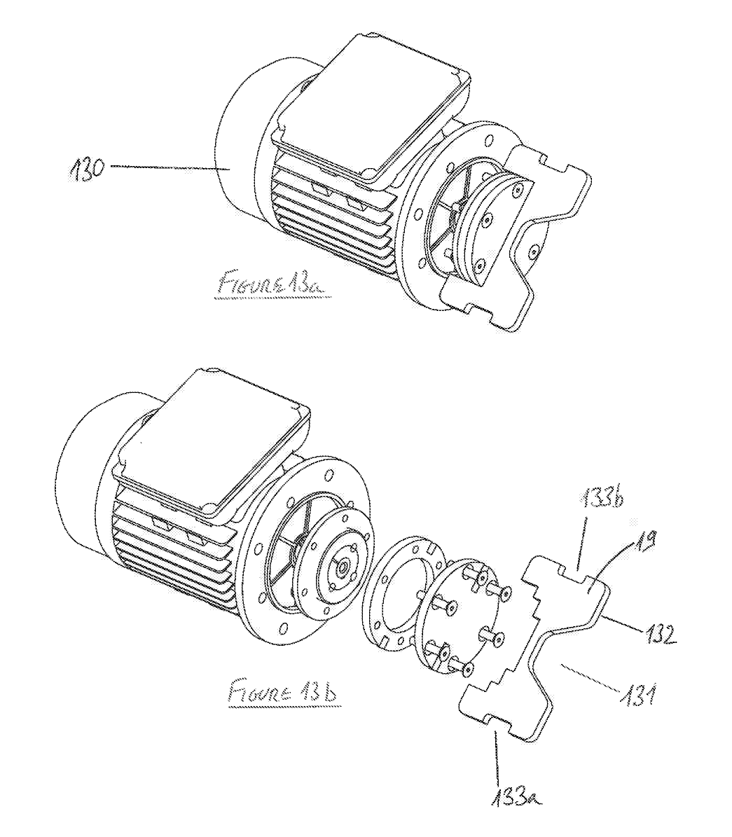

Details of the blade 19 and the blade housing to the motor 130 are shown in FIG. 13. The motor 130 shown is a three-phase motor which enables firstly smoother and hence quieter and more efficient operation of blade 19 than a single phase motor. A single phase motor can nevertheless be used. Second, the three-phase motor is more easily able to cope with use of the device in which the motor is repeatedly switched on, runs for a short period of time and is then switched off, which is a typical use scenario for the present invention.

With regard to the blade 19, this can be seen to have a generally trapezoidal cut-out 131 along its outer edge 132. It will be appreciated that most bottles which are inserted into the device 60 have their labels still attached. Labels, by virtue of the adhesive used to secure the label to the bottle can adversely affect the breakage process. The labels can moreover result in the valve's function being substantially sub-optimal. Should the label remain intact, the outlet hole would be required to be much larger, which increases the risk of an increased quantity of airborne matter being released. The device 60 allowing for this to be the case and will simplify the user's task considerably as a pre-breakage cleaning step to remove the label will not need to be undertaken. The cut-out provides a convoluted path which a bottle needs to traverse through the machine so that the chance of a label passing through flat and avoiding fragmentation of the portion of the bottle to which it is attached is considerably reduced.

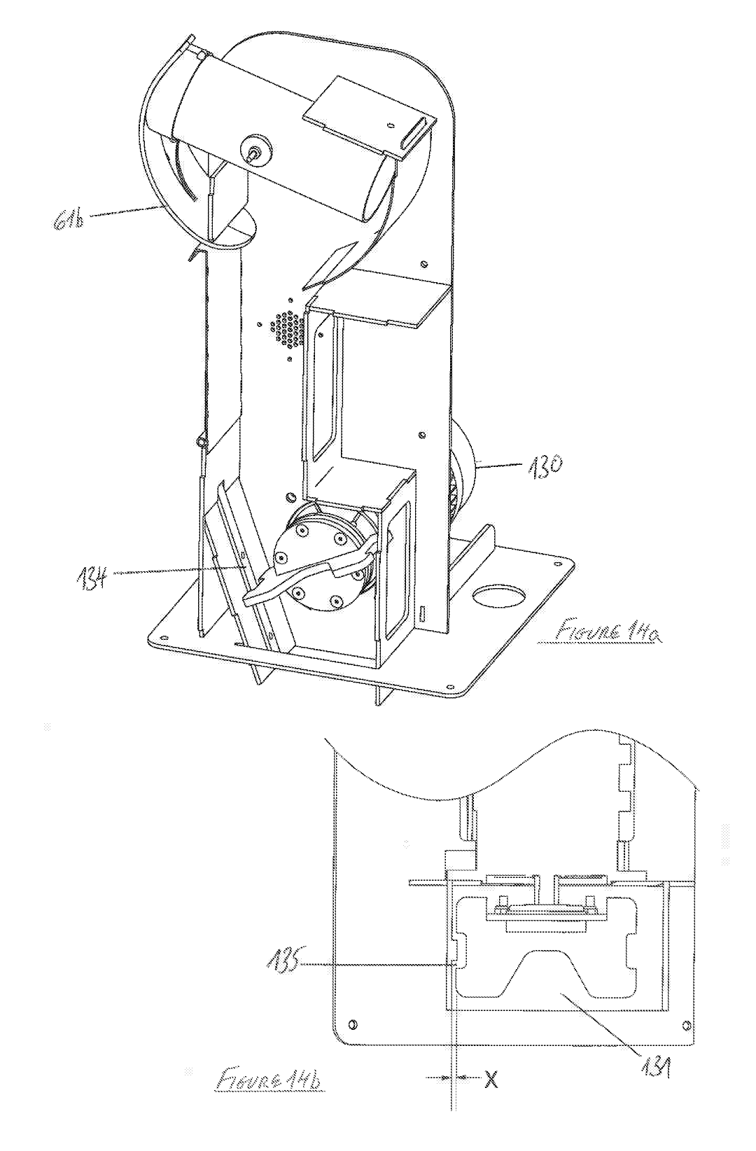

In addition, to aid this process, the blade 19 can also comprise one or more further cut-outs. In the embodiment shown in FIG. 14, the further cut-outs 133a, b are located on a separate edge to the cut-out 131. The shape of the further cut-outs 133a, b are chosen to be complementary to a rib 134 on the crusher plate 20. A spacing 135 is included between the blade 19 and the crusher plate 20 and the rib 134 to allow passage of glass particles between these two elements, with the spacing 135 being selected to be large enough such that the glass is not reduced to a particle size which is too small. A typical spacing is 5 to 30 mm, and preferably 5 to 10 mm, depending on the particle size desired.

In order to reduce dust generation, which can occur on pressure build-up within the breakage unit 14, an air circulation breather pipe 155 is included linking the outlet of the breakage unit 14 with the conduit 13. The breather pipe 155 also aids in noise reduction by minimising the opportunity for standing waves to build-up within the machine.

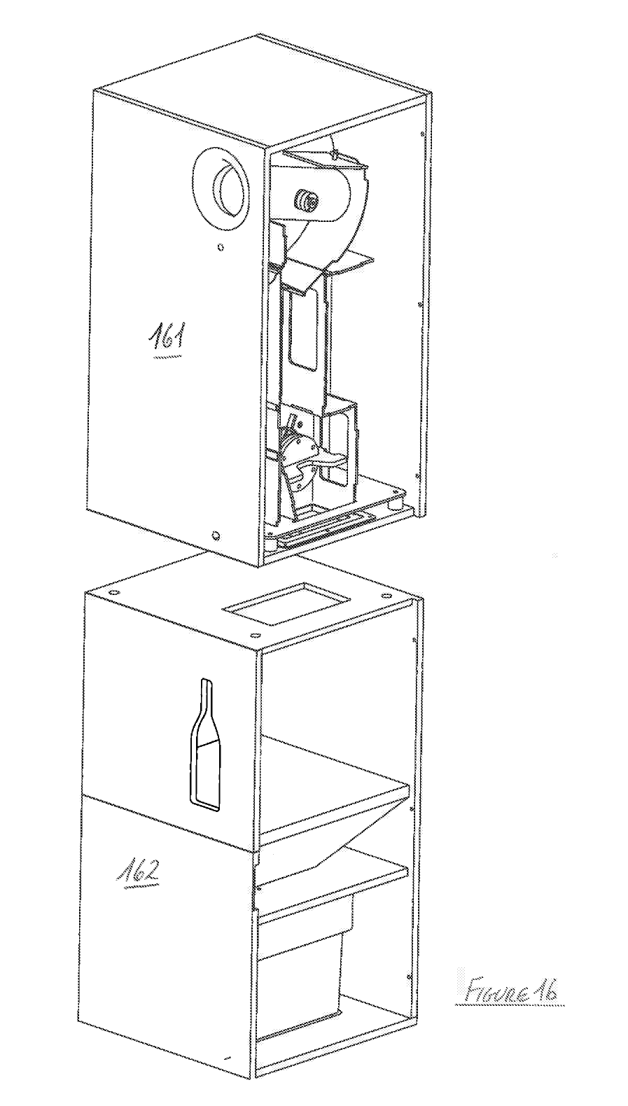

In FIG. 16, an embodiment is shown in which the inlet and breakage units are provided in a first cabinet 161 and the hopper and container units are provided in a second cabinet 162. This embodiment enables the device to be supplied to the user in more easily handleable packaging with the two units being secured together on site. In an alternative embodiment, not illustrated, the first cabinet 161 can be mounted to a counter top for discharge into a tube. This allows collection of broken glass into containers of different sizes, depending on space available and the wishes of the user.

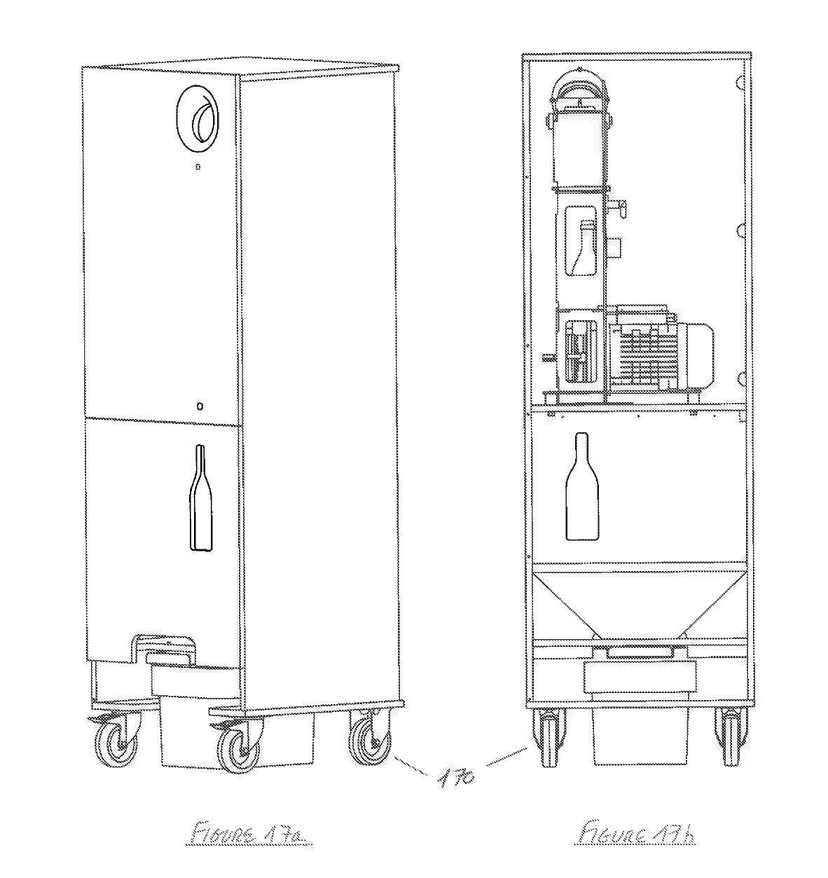

In FIG. 17a, 17b the device, in accordance with the above described embodiments is mounted on castors 170 for ease of manoeuvring between locations.

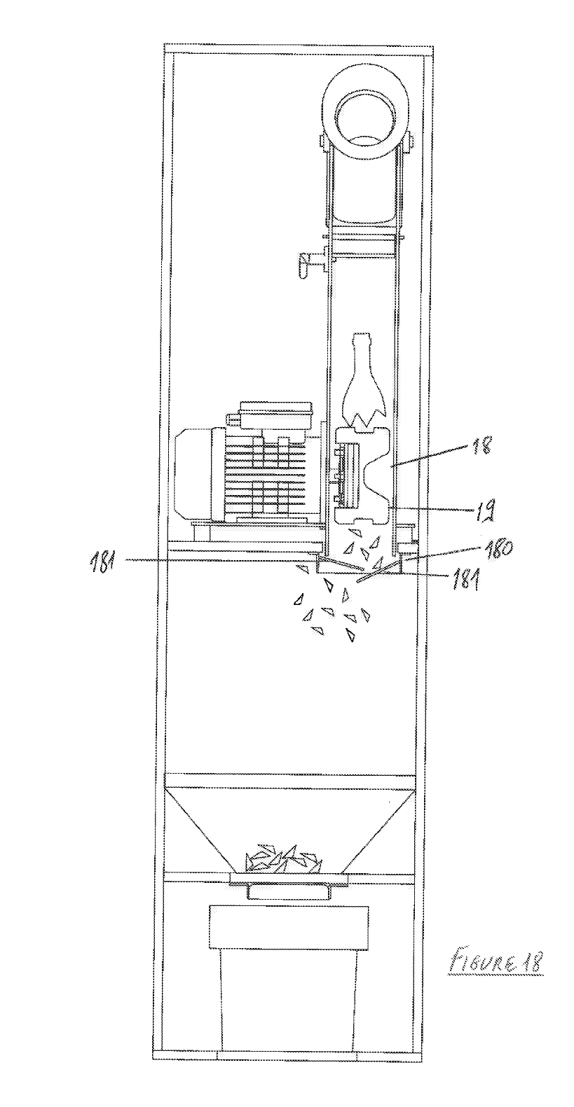

In FIG. 18 a further noise reduction means is disclosed, for use in conjunction with the above-disclosed embodiments. A silencer or baffle box is located beneath the outlet from the breaking chamber 18. The glass particles exiting from the breaking chamber 18 can have a high velocity due to the action of the blade 19 and gravity. The noise generated as the particles impact the sides of the device can therefore be substantial.

The silencer 180 acts to decelerate the glass particles, which reduces the noise generated in any impact. The silencer 180 comprises 2 overlapping angled rubber flaps 181 and on impact with these flaps 181, the particles lose momentum and are deflected away from the sides. It will be appreciated that additional flaps 181 can be utilised if deemed necessary.

It will be recognised that the invention has not alluded to the specific details described herein, which are given by way of example only, and that various modifications and alterations are possible within the scope of the invention.

1. A device for breaking glass articles, such as bottles, the device comprising;
an inlet to receive an article,
a conduit linking the inlet with a glass-breaking chamber, the chamber housing a glass-breaking member, said glass-breaking member being rotatably mounted for rotation in a vertical plane, and to impact a bottle as a bottle enters the chamber;
a motor linked via a horizontally rotating axle to rotate the glass-breaking member;
an obliquely mounted crusher plate located such that as the glass-breaking member rotates and impacts a glass article is forced against the crusher plate by the glass-breaking member to aid breakage of a glass article;
a collector in which broken glass is retained ready for removal from the device;
an intermediate collector to temporarily retain broken glass, including a release valve allowing broken glass to pass from the intermediate collector to the collector, via an aperture therebetween.

2. A device according to claim 1, wherein the crusher plate includes a rib.

3. A device according to claim 1, wherein, the glass breaking member includes a blade extending perpendicularly from a mounting plate.

4. A device according to claim 3, wherein the blade has a generally rectangular profile.

5. A device according to claim 3, wherein the blade includes a cut-out of complementary shape to the rib and which in use passes in close spaced-relationship with said rib as the blade rotates.

6. A device according to claim 5, wherein the blade includes a further cut-out along an edge to provide a further, non-linear path for a glass bottle to traverse.

7. A device according to claim 1, wherein the device includes an input chute pivotally mounted, such that insertion of a bottle into the chute beyond the mount acts to pivot the chute into a vertically orientated position, releasing the bottle into the conduit.

8. A device according to claim 7, wherein pivoting of the chute to the bottle releasing orientation, activates an inlet closure means.

9. A device according to claim 1, wherein the release valve mounted on rollers.

10. A device according to claim 1, wherein the release valve includes a plate element.

11. A device according to claim 1, wherein the release valve includes a gripping portion.

12. A device according to claim 1, wherein the device includes one or more brushes in contact with and extending across the width of the release valve.

13. A device according to claim 10, wherein, the plate element includes a ridge across the width of the plate element.

14. A device according to claim 7, wherein the chute in its rest position opens onto a back retaining wall to prevent a bottle from sliding too far.

15. A device according to claim 14, wherein the back retaining wall is formed of a material having a low co-efficient of friction such as Teflon®, HDPE or UHMWPE.

16. A device according to claim 14, wherein the back retaining wall is concavely curved.

17. A device according to claim 1, wherein the conduit comprises sound-insulating material.

18. A device according to claim 17, wherein the sound-insulating material comprises a perforated metal sheet backed with an absorptive foam or an open-cell material.

19. A device according to claim 1, wherein, the rotation of the glass breaking member is at a speed of from 1000-3000 rpm.

20. A device according to claim 1, wherein the collector includes one or more sensors, to determine the level of glass within the collector, which level is communicated to a user when the level reaches a preset value.

21. A device according to claim 1, wherein the or each sensor is an ultrasonic sensor.

22. A device according to claim 21, wherein the or each sensor is mounted on an upper surface of the collector.

23. A device according to claim 20, wherein the preset level at which communication to a user takes place is set at 200 mm from the top or 100 mm.

24. A valve for controlling the flow of particulate solid through an aperture, the valve comprising a plate element, moveable between an aperture-spanning position preventing flow and an open position,
the plate element being housed within a valve housing and mounted on rollers to ease movement,
one or more brush elements mounted within the housing, the or each brush element engaging a surface of the plate element to prevent movement of particles beyond the brush and so effectively sweep the plate element as the plate element is moved within the housing.

25. A device according to claim 24, wherein the plate element includes a ridge, across the width of the plate element.

26. A device according to claim 25, wherein the plate element includes a gripping portion to facilitate operation of the plate element.

27. A device according to claim 24, wherein movement of the plate element is actuated by a motor drive unit.

28. (canceled)
